(19) United States
(12) Patent Application Publication
(10) Pub. No.: US 2002/0106561 A1
(43) Pub. Date: Aug. 8, 2002

(54) Positive electrode for a lithium-sulfur battery and a lithium-sulfur battery including the positive electrode

(75) Inventors: Jaewoan Lee, Cheonan-city (KR); Yunsuk Choi, Cheonan-city (KR); Yongju Jung, Cheonan-city (KR); Soo Seok Choi, Cheonan-city (KR); Duck Chul Hwang, Cheonan-city (KR); Joo Soak Kim, Cheonan-city (KR)

Correspondence Address: STAAS & HALSEY LLP, 700 11TH STREET, NW, SUITE 500, WASHINGTON, DC, 20001, US

(73) Assignee: SAMSUNG SDI CO., LTD., Suwon-city (KR)

(21) Appl. No.: 09/986,919

(22) Filed: Nov. 13, 2001

(30) Foreign Application Priority Data
Nov. 22, 2000 (KR) 2000-69642

(51) Int. Cl. H01M 4/58; H01M 4/80; H01M 4/66

(52) U.S. Cl. 429/218.1; 429/231.95; 429/234; 429/236; 427/58; 29/2

(57) ABSTRACT

A positive electrode for a lithium-sulfur battery that includes a sulfur-based positive active material, a conductive agent and a binder filled in a porous current collector. The lithium-sulfur battery having the positive electrode can improve capacity characteristics by enhancing the utilization of the sulfur-based positive active material, and also improve cycle life characteristics by inhibiting the detachment of the active material from the current collector.

### CROSS REFERENCE TO RELATED APPLICATION

This application is based on Korean Patent Application No. 2000-69642 filed in the Korean Industrial Property Office on Nov. 22, 2000, the content of which is incorporated herein by reference.

### BACKGROUND OF THE INVENTION

1. Field of the Invention

The present invention relates to a positive electrode for a lithium-sulfur battery and a lithium-sulfur battery having the same, and, more particularly, to a positive electrode for a lithium-sulfur battery exhibiting improved utilization efficiency of an active material and charge-discharge efficiency, and a lithium-sulfur battery having the same.

2. Description of the Related Art

A lithium-sulfur battery uses a sulfur-based compound having a sulfur-sulfur bond as a positive active material, and a metallic material, such as lithium, as a negative active material. Upon discharging, the sulfur-sulfur bond is decomposed to lead to a sulfur-lithium compound by an electrochemical reduction reaction with a lithium ion. Upon recharging, the sulfur-lithium compound is decomposed to reform a sulfur-sulfur compound by an electrochemical oxidation reaction. The lithium-sulfur battery saves and produces electric energy by the above reduction and oxidation reactions.

In the conventional lithium-sulfur battery, the positive electrode is made by the following procedure: dispersing a binder and a conductive agent in an organic solvent; making a slurry by adding a positive active material in the dispersed solution; spreading the slurry on a current collector, and drying the coated current collector. The structure of the conventional positive electrode prepared as described above is illustrated in FIG. 1. In general, the current collector comprises a metal foil.

In the conventional positive electrode illustrated in FIG. 1, the reaction surface of the active material is relatively narrow. Thus, the utilization of the active material is rather low because the active material is coated on the current collector. In particular, the active material is detached from the current collector during charging-discharging. This detachment causes problems such as the reduction of the charge-discharge efficiency. In addition, in the absence of the conductive agent at the farthest side from the current collector, the active material is likely to become a non-active material. Thus, the overall capacity of the battery is likely to decrease.

### SUMMARY OF THE INVENTION

To solve the above and other problems, it is an object of the present invention to provide a positive electrode for a lithium-sulfur battery exhibiting an improved utilization efficiency of an active material and an improved charge-discharge efficiency.

It is another object to provide a positive electrode for a lithium-sulfur battery with a high capacity.

It is still another object to provide a lithium-sulfur battery having the positive electrode.

Additional objects and advantages of the invention will be set forth in part in the description which follows and, in part, will be obvious from the description, or may be learned by practice of the invention.

In order to achieve these and other objects, a positive electrode for a lithium-sulfur battery according to an embodiment of the present invention includes a current collector having pores, a positive active material, a conductive agent, and a binder filled in the pores of the porous current collector.

According to another embodiment of the present invention, a lithium-sulfur battery includes a positive electrode having a porous current collector, a combination of a sulfur-based active material, a conductive agent, and a binder disposed in pores of the porous current collector, and a negative active material selected from the group consisting of a material which can intercalate/deintercalate lithium ions, a material which can reversibly reform a chemical compound with lithium, a lithium metal, and a lithium-containing alloy, a separator interposed between the positive and the negative electrodes, and an electrolyte impregnated into the negative electrode, the positive electrode, and the separator, and which includes a lithium salt and an organic solvent.

### BRIEF DESCRIPTION OF THE DRAWINGS

A more complete appreciation of the invention, and many of the attendant advantages thereof, will be more readily apparent and appreciated as the same becomes better understood by reference to the following detailed description when considered in conjunction with the accompanying drawings, wherein:

FIG. 1 is a schematic view illustrating a positive electrode for a conventional lithium-sulfur battery made by using a current collector according to the conventional procedure.

FIG. 2 is a schematic view illustrating a positive electrode for a lithium-sulfur battery made by the use of the current collector according to an embodiment of the present invention.

FIG. 3 shows a lithium-sulfur battery according to an embodiment of the present invention.

### DETAILED DESCRIPTION OF THE PREFERRED EMBODIMENTS

In the following detailed description, the preferred embodiments of the invention are shown and described. As will be realized, the invention is capable of modification in various obvious respects, all without departing from the nature and spirit of the invention. Accordingly, the drawings and description are to be regarded as illustrative in nature, and not restrictive. The embodiments are described below in order to explain the present invention by referring to the drawings.

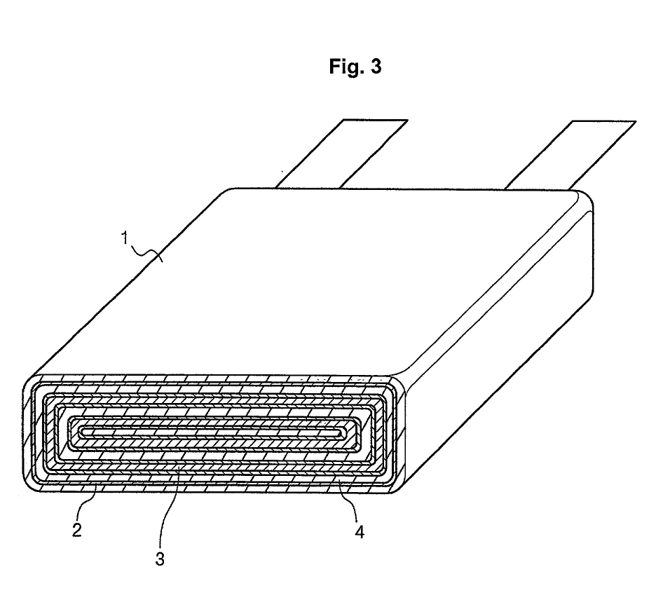

As shown in FIGS. 2 and 3, a lithium-sulfur battery according to an embodiment of the present invention includes a case 1 containing a positive electrode 3, a negative electrode 4, and a separator 2 interposed between the positive electrode 3 and the negative electrode 4. The positive electrode 3 for a lithium-sulfur battery includes a current collector having pores prepared from a conductive material, an active mass comprising a sulfur-based positive active material, a conductive agent, and a binder filled in the pores of the current collector.

The conductive material of the current collector includes stainless steel, aluminum, titanium, and mixtures thereof etc. Among them, a carbon-coated aluminum current collector is most preferable. The current collector of the present invention comprises a felt or foam type having a porosity over 5%, preferably over 60%, and more preferably 80 to 98% of the overall volume of the current collector.

The porous current collector can be manufactured as follows:

A resin foam, such as polyurethane, is coated with a metal and is subjected to a pyrolysis process. During the pyrolysis process, after the coated resin foam is removed, a plurality of pores form to prepare the porous current collector. A conductive agent, such as carbon, can be added to the foam prior to the metal coating to improve the conductivity of the current collector, but is not required in all circumstances.

According to another embodiment of the invention, a metal-coated non-woven fabric made of carbon fibers having a diameter of several tens of micrometers or a carbon fiber itself can be used as a porous current collector. In addition, the metal-coating method includes electroplating, and electroless plating, and the coated metal includes nickel, aluminum and mixtures thereof, and other similar metals and methods of coating the metal.

The sulfur-based active material of the present invention preferably includes at least one compound selected from the group consisting of elemental sulfur, solid Li₂Sₙ (n≧1), a catholyte in which Li₂Sₙ (n≧1) dissolves, an organosulfur compound and a carbon-sulfur polymer. Of these, it is preferred to use elemental sulfur, a solid Li₂Sₙ (n≧1), and a catholyte in which Li₂Sₙ (n≧1) dissolves. In the present invention, the catholyte is referred to as the solution where the positive active material dissolves in an electrolyte. The catholyte in which Li₂Sₙ (n≧1) dissolves is preferable since the capacity increases as the concentration of the sulfur of the polysulfide in the electrolyte increases.

The conductive agent is preferably selected from carbonaceous materials such as carbon black and a conductive polymer such as polyaniline, polythiophene, polyacetylene, polypyrrole, or mixtures thereof. The conductive agent in the positive electrode 3 helps the electrons to transfer well in the active material. However, it is understood that other conductive agents may be used to achieve the same or similar result.

Examples of the binder include an acrylate polymer, such as polytetrafluoroethylene (PTFE), a polyvinylidene fluoride (PVDF), a UV-curable vinyl polymer, and a polymethylmethacrylate (PMMA). The weight ratio of the sulfur-based compound, the conductive agent, and the binder is preferably 60-80: 5-20: 5-20. However, it is understood that other binders and weight ratios may be used.

The preparation method of the positive electrode 3 according to an embodiment of the present invention can be different according to the sulfur-based positive active material. When a solid sulfur compound, such as the elemental sulfur, the solid Li₂Sₙ (n≧1) organosulfur compound and the carbon-sulfur polymer, is used, the positive electrode 3 is prepared using a coating (casting) method. In contrast, when the catholyte in which Li₂Sₙ (n≧1) dissolves is used, the Li₂Sₙ (n≧1) dissolves in the electrolyte to prepare the catholyte which is used as the positive electrode 3.

In the coating method, a binder such as polytetrafluoroethylene (PTFE), polyvinylidene fluoride (PVDF) or UV-curable vinyl polymer, polymethylmethacrylate (PMMA) dissolves in the solvent, and a conductive agent is dispersed therein to obtain a dispersion solution. At least one sulfur-based compound selected from the group consisting of elemental sulfur, solid Li₂Sₙ (n≧1) and organosulfur compound and carbon-sulfur polymer is added to the dispersion solution and uniformly dispersed to prepare a slurry for a positive electrode 3. The solvent is required to have such characteristics to uniformly disperse the sulfur-based compound, the binder and the conductive agent, and to evaporate easily. The solvents preferably include acetonitrile, methanol, ethanol, tetrahydrofuran, water, and other similar solvents. In the present invention, the solvent and the quantity of the sulfur-based compound are not particularly important, but the adequate viscosity of the slurry is required in order for it to be easily coated.

The slurry prepared by the coating method is coated on a porous current collector, and dried under a vacuum condition. The positive electrode 3 prepared as above is used for preparing] in a lithium-sulfur battery. The slurry is preferably coated on the current collector according to a viscosity of the slurry and a thickness of the positive electrode 3.

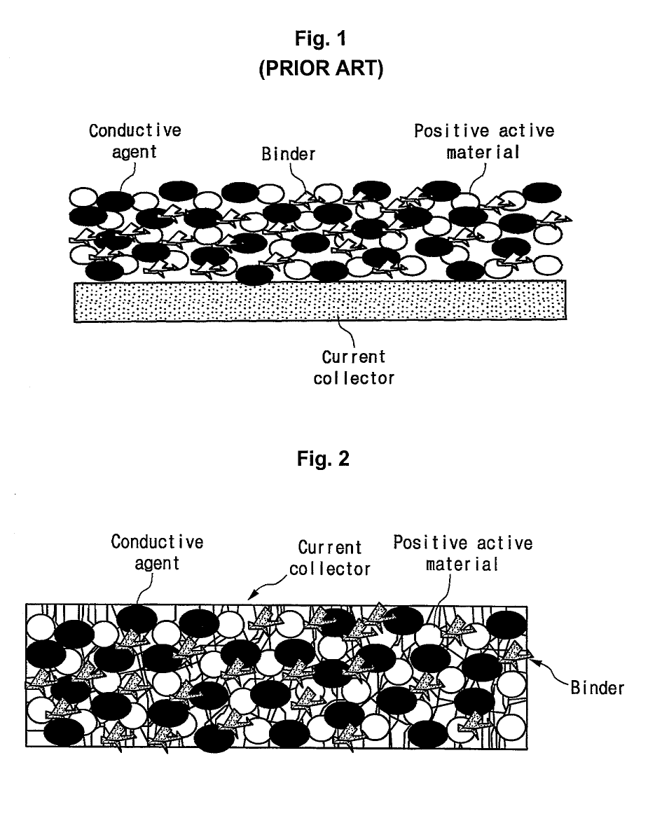

The positive electrode 3 of an embodiment of the present invention is illustrated in FIGS. 2 and 3. As shown in FIG. 2, the reaction site of the positive electrode 3 having the porous current collector is larger than that of the conventional foil-type current collector shown in FIG. 1. In case the conventional foil-type current collector is used, when the conductive agent is absent around the active materials farthest away from the current collector, these active materials lose conductivity.

However, the conductivity of the active material of the positive electrode 3 shown in FIG. 2 can increase by the conductivity of the current collector because the sulfur-based active material is inserted into the pores of the current collector. In other words, even when the conductive agent is absent around the positive active material, because each of the pores of the current collector surrounds the positive active material, the positive active material can be received electron] receive electrons and remain active. The utilization of the sulfur-based positive active material according to an embodiment of the present invention can be improved, and thus the present invention provides a high capacity lithium-sulfur battery. Also, because the sulfur-based positive active material is inserted into the current collector, the detachment of the active material from the current collector can be protected during charging-discharging, and also the charging-discharging efficiency can be improved.

The positive electrode 3 according to an embodiment of the present invention is used together with a solid electrolyte or a liquid electrolyte. The solid electrolyte functions as a vehicle for the transfer of the metal ions and physically separates the positive electrode 3 and the negative electrode 4 as to act as a separator 2. Therefore, any electron and ion conductive material with electrochemical stability preferably can be used.

The examples of an electron and ion conductive material include a glass electrolyte, a polymer electrolyte, and a ceramic electrolyte. It is preferable that the solid electrolyte comprises a suitable electrolyte salt and a polymer electrolyte such as polyether, polyimine, polythioether, etc. The solid electrolyte can comprise less than 20% of non-aqueous organic solvent, and can further comprise a gelling agent to reduce the fluidity of the organic solvent. Any organic solvent can be used as long as the organic solvent can be used in the lithium-sulfur battery. The examples of the organic solvent include 1,3-dioxolan, diglyme, sulforane, dimethoxy ethane or mixtures thereof. Any lithium salt can be used as long as the lithium salt can be used in the lithium-sulfur battery. Examples of the lithium salt include LiSO₃CF₃, LiClO₄, LiPF₆ and LiBF₄.

The non-aqueous electrolyte can be used generally as the liquid electrolyte which can be used with the positive electrode 3 according to an embodiment of the present invention. The liquid electrolyte can further comprise the separator 2 comprising a porous glass, plastic, ceramic or polymer as a separating membrane.

The negative active material can be a material which can reversibly intercalate/deintercalate the lithium ion, a lithium metal, a material which can form a chemical compound with a lithium metal, or a lithium-containing alloy. A lithium/aluminum alloy or lithium/tin alloy may be used as the lithium-containing alloy. Also, during charging-discharging of the lithium-sulfur battery, sulfur used as the sulfur-based positive active material is transformed into an inactive material, and can be attached to the surface of the lithium negative electrode 4. Inactive sulfur is referred to as the sulfur which can not participate in the electrochemical reaction of the positive electrode 3 through various electrochemical and chemical reactions. Inactive sulfur formed on the surface of the negative electrode 4 has the advantage. Specifically, inactive sulfur forms a protective layer on the lithium negative electrode 4. Therefore, the lithium metal and the inactive sulfur formed on the lithium metal, such as lithium sulfide, can be used as a negative electrode 4.

Any carbonaceous negative active material generally used in the lithium ion secondary battery can be used as the material which can intercalate/deintercalate the lithium ion reversibly. Examples of the carbonaceous negative active material include crystalline carbon, non-crystalline carbon and mixtures thereof. Also, an example that can reversibly form a compound with the lithium metal is titanium nitrate, but is not limited thereto.

The following Examples are presented to better illustrate the invention, but are not to be construed as limiting the invention to the specific embodiments disclosed.

### EXAMPLE 1

A binder solution was prepared by dissolving polyvinylacetate in acrylonitrile. A carbon powder (super P) conductive agent was added to the binder solution to obtain a dispersion solution. A sulfur powder, which was pulverized to a mean diameter of about 20 μm, was added to the dispersion solution, and the dispersion solution was agitated by a ball-mill for over 24 hours. A positive active material slurry was prepared from the agitated dispersion solution. The weight ratio of the sulfur: the binder: and the conductive agent in the positive active material slurry was 60:20:20.

The positive active material slurry was coated on the nickel foam having 80% of porosity, and the slurry-coated nickel foam was dried at 60° C. for 1 hour. The dried slurry-coated nickel foam was pressed to a thickness of 50 μm by a roll presser to prepare the positive electrode.

### EXAMPLE 2

The positive electrode was prepared by the same method as in Example 1, except that a current collector was a non-woven fabric having 80% porosity that was coated with nickel.

### EXAMPLE 3

The positive electrode was prepared by the same method as in Example 1, except that a current collector having 80% porosity was used.

### Comparative Example 1

A binder solution was prepared by dissolving polyvinylacetate in acrylonitrile. A carbon powder (super P) was added as a conductive agent to the binder solution to obtain a dispersion solution. A sulfur powder, which was pulverized to a mean diameter of about 20 μm, was added to the dispersion solution, and the dispersion solution was agitated by a ball-mill for over 24 hours. From the agitated dispersion solution, a positive active material slurry was prepared. The weight ratio of the sulfur: the binder: and the conductive agent in the positive active material slurry was 60:20:20.

The positive active material slurry was coated on an aluminum foil, and the coated aluminum foil was dried at 60° C. for 1 hour. The dried aluminum foil was then pressed to a 50 μm thickness by a roll presser to prepare a positive electrode.

After the positive electrodes prepared in Example 1 and Comparative example 1 were prepared, they were placed in a vacuum-oven (60° C.) over 24 hours, and then were transferred into a glove-box in which moisture and oxygen were controlled.

After the positive and negative electrodes were cut to an adequate size and taps were adhered to the positive and negative electrodes, the positive and negative electrodes were wound spirally with the separator being interposed between the positive and negative electrodes to prepare an electrode group. The electrode group was inserted into a pouch, which was sealed up except for an opening part into which an electrolyte was inserted. A non-oxidized lithium metal foil having a thickness of 50 μm was used as the reference positive electrode. The mixture of 1,3-dioxolan, diglyme, sulforane and dimethoxyethane (50:20:10: 20 ratio by volume) in which 1M of LiSO₃CF₃ was dissolved was inserted into the pouch to fabricate the lithium-sulfur cell.

The cycling capability and capacity retention of the cells prepared as above were evaluated after undergoing charge-discharge 4 times at 0.1C, 3 times at 0.2C and 3 times at 0.5C. The results are shown in Table 1.

TABLE 1

| | Cycle capacity (mAh/g) | | | Capacity retention (%) | | |
|---|---|---|---|---|---|---|
| | 1 cycle | 4 cycles | 10 cycles | 1 cycle | 4 cycles | 10 cycles |
| Example 1 | 645 | 506 | 352 | 100 | 78 | 54 |
| Example 2 | 650 | 500 | 370 | 100 | 77 | 57 |
| Example 3 | 646 | 507 | 350 | 100 | 78 | 54 |
| Compara- | 520 | 356 | 196 | 100 | 68 | 38 |
| tive | | | | | | |
| example 1 | | | | | | |

Notice: the capacity retention is the remaining capacity/the first cycle capacity (%)

As shown in Table 1, the cell of the Example 1 exhibited a good initial capacity because of the improvement of the utilization of the positive active material, and exhibited a smaller decrease of capacity during charging-discharging cycles according to the improvement of the charging-discharging efficiency.

The lithium-sulfur battery of the present invention can improve the capacity characteristics of the battery by enhancing the utilization of a sulfur-based active material, and also improve the cycle life characteristics of the battery by inhibiting the detachment of the active material from the current collector.

While the present invention has been described in detail with reference to the preferred embodiments, those skilled in the art will appreciate that various modifications and substitutions can be made thereto without departing from the spirit and scope of the present invention as set forth in the accompanying claims and equivalents thereof.

What is claimed is:

1. A positive electrode for a lithium-sulfur battery comprising:
a current collector having pores; and
a positive active mass comprising a sulfur-based active material, a conductive agent, and a binder disposed in the pores of said current collector.

2. The positive electrode of claim 1, wherein the sulfur-based active material is at least one selected from the group consisting of elemental sulfur, solid Li₂Sₙ (n≧1), a catholyte in which Li₂Sₙ (n≧1) dissolves, an organosulfur compound, and a carbon-sulfur polymer.

3. The positive electrode of claim 1, wherein the pores of said current collector comprise at least 60% porosity of an overall volume of said current collector.

4. The positive electrode of claim 1, wherein the pores of said current collector comprise at least 80 to 90% porosity of an overall volume of said current collector.

5. The positive electrode of claim 1, wherein said porous current collector comprises a resin foam coated with a metal, where the coated resin foam is subjected to a pyrolysis process.

6. The positive electrode of claim 5, wherein said porous current collector further comprises a conductive agent.

7. The positive electrode of claim 1, wherein said porous current collector comprises a non-woven fabric coated with a metal.

8. The positive electrode of claim 1, wherein said porous current collector comprises a carbon fiber.

9. The positive electrode of claim 5, wherein the metal is coated using a coating method that comprises one of electroplating and electroless plating.

10. The positive electrode of claim 7, wherein the metal is coated using a coating method that comprises one of electroplating and electroless plating.

11. The positive electrode of claim 5, wherein the metal is at least one selected from the group consisting of nickel, aluminum, and mixtures thereof.

12. The positive electrode of claim 7, wherein the metal is at least one selected from the group consisting of nickel, aluminum, and mixtures thereof.

13. A lithium-sulfur battery comprising:
a positive electrode comprising a current collector having pores, a sulfur-based active material, a conductive agent, and a binder disposed in the pores of the current collector;
a negative electrode comprising a negative active material selected from the group consisting of a material which can reversibly intercalate/deintercalate lithium ions, a material which can reversibly reform a chemical compound with lithium, a lithium metal, and a lithium- containing alloy;
a separator interposed between said positive electrode and said negative electrode; and
an electrolyte impregnated into said negative electrode, said positive electrode, and said separator, and which comprises a lithium salt and an organic solvent.

14. The lithium-sulfur battery of claim 13, wherein the sulfur-based positive active material is at least one selected from the group consisting of elemental sulfur, solid Li₂Sₙ (n≧1), a catholyte in which Li₂Sₙ (n≧1) dissolves, an organosulfur compound, and a carbon-sulfur polymer.

15. The lithium-sulfur battery of claim 13, wherein the pores of the current collector comprise at least 60% porosity of an overall volume of the current collector.

16. The lithium-sulfur battery of claim 13, wherein the pores of the current collector comprise 80 to 90% porosity of an overall volume of the current collector.

17. The lithium-sulfur battery of claim 13, wherein the porous current collector comprises a resin foam coated with a metal, where the coated resin foam was subjected to a pyrolysis process.

18. The lithium-sulfur battery of claim 17, wherein the porous current collector further comprises a conductive agent.

19. The lithium-sulfur battery of claim 13, wherein the porous current collector comprises a non-woven fabric coated with a metal.

20. The lithium-sulfur battery of claim 13, wherein the porous current collector comprises a carbon fiber.

21. The lithium-sulfur battery of claim 17, wherein the metal is coated using a coating method that is one of electroplating and electroless plating.

22. The lithium-sulfur battery of claim 19, wherein the metal is coated using a coating method that is one of electroplating and electroless plating.

23. The lithium-sulfur battery of claim 17, wherein the metal is at least one selected from the group consisting of nickel, aluminum and mixtures thereof.

24. The lithium-sulfur battery of claim 19, wherein the metal is at least one selected from the group consisting of nickel, aluminum and mixtures thereof.

25. A lithium sulfur battery, comprising:
a positive electrode comprising a current collector having pores and with each pore having a conductive surface, and a positive active mass comprising a sulfur-based active material disposed in the pores contacting the conductive surfaces;
a negative electrode comprising a negative active material selected from the group consisting of a material which can reversibly intercalate/deintercalate lithium ions, a material which can reversibly reform a chemical compound with lithium, a lithium metal, and a lithium-containing alloy; and
an electrolyte to transfer metal ions and to separate said positive and negative electrodes.

26. The lithium sulfur batter of claim 25, wherein said electrolyte comprises one of a glass electrolyte, a polymer electrolyte, and a ceramic electrolyte.

27. The lithium sulfur batter of claim 26, wherein said electrolyte further comprises an electrolyte salt.

28. The lithium sulfur batter of claim 27, wherein said electrolyte further comprises less than 20% of a non-aqueous organic solvent, and a gelling agent to reduce a fluidity of the organic solvent.

29. The lithium-sulfur battery of claim 25, wherein the pores of the porous current collector comprise at least 60% porosity of an overall volume of the porous current collector.

30. The lithium-sulfur battery of claim 25, wherein the porous current collector comprises a resin foam coated with a metal.

31. The lithium-sulfur battery of claim 25, wherein the porous current collector comprises a non-woven fabric coated with a metal.

32. A method of manufacturing a positive electrode for a lithium-sulfur battery, the method comprising:
obtaining a current collector having pores with each of the pores having conductive surfaces; and
inserting a positive active mass comprising a sulfur-based active material into the pores to contact the conductive surfaces.

33. The method of claim 32, wherein said obtaining the current collector comprises:
coating a resin foam with a metal; and
processing the coated resin foam using a pyrolysis process.

34. The method of claim 33, wherein said obtaining the current collector further comprises adding a conductive agent to the resin foam prior to coating the resin foam.

35. The method of claim 33, wherein the coating the resin foam with the metal comprises using one of electroplating and electroless plating to coat the metal.

36. The method of claim 35, wherein the metal is at least one selected from the group consisting of nickel, aluminum, and mixtures thereof.

37. The method of claim 32, wherein said obtaining the current collector comprises coating a non-woven fabric coated with a metal.

38. The method of claim 37, wherein the non-woven fabric comprises a carbon fiber.

39. The method of claim 37, wherein the coating the non-woven fabric with the metal comprises using one of electroplating and electroless plating to coat the metal.

40. The method of claim 39, wherein the metal is at least one selected from the group consisting of nickel, aluminum, and mixtures thereof.

41. The method of claim 32, wherein the sulfur-based active material comprises a solid sulfur compound, the method further comprising:
dissolving a binder and a conductive agent in a solvent to obtain a dispersion solution; and
adding the solid sulfur compound to the dispersion solution to be uniformly dispersed therein to form a slurry;
wherein said inserting the positive active mass comprises coating the slurry on the porous current collector.
